(19) United States
(12) Patent Application Publication
(10) Pub. No.: US 2022/0410071 A1
(43) Pub. Date: Dec. 29, 2022

(54) LOW TEMPERATURE SEPARATION METHOD USING 2D MATERIAL-BASED NANOCOMPOSITE COATING

(71) Applicant: NATIONAL UNIVERSITY OF SINGAPORE, Singapore (SG)

(72) Inventors: Marcos Vinicius SURMANI MARTINS, Singapore (SG); Antonio Helio CASTRO NETO, Singapore (SG); Juan Alfredo GUEVARA CARRIO, Singapore (SG); Marta Hanna MIKS, Horsholm (DK)

(21) Appl. No.: 17/775,021

(22) PCT Filed: Nov. 2, 2020
(86) PCT No.: PCT/SG2020/050627

§ 371 Date: May 6, 2022

(30) Foreign Application Priority Data
Nov. 8, 2019 (SG) 10201910488S

(51) Int. Cl. B01D 63/06; B01D 61/36; B01D 69/02; B01D 71/02; B01D 71/38

(52) U.S. Cl. CPC B01D 63/066; B01D 61/363; B01D 69/02; B01D 71/0211; B01D 71/381; B01D 2323/06; B01D 2311/13; B01D 69/148

(57) ABSTRACT

The present invention provides a nanocomposite coating comprising: a two-dimensional material; and a polymer, wherein the nanocomposite coating is semi-permeable and is for providing on porous material to improve selectivity towards one phase over others thereby enabling separation of that phase by mass transfer. There is also provided a phase transformation and mass transfer unit comprising porous material coated with the nanocomposite coating, and a low temperature liquid phase separation method comprising flowing liquid mixture through a phase transformation and mass transfer unit comprising porous material coated with the nanocomposite coating.

### TECHNICAL FIELD

The present invention relates to a 2D material-based nanocomposite coating and a liquid phase separation method using the nanocomposite coating.

### BACKGROUND

Separation processes of liquid phase systems are fundamental in a vast number of modern industrial applications. The technological processes exploit the differences in physical and chemical properties of the compounds of interest to be separated and isolated in their pure form or in different mixtures or compositions. Methods based on liquid-vapour or liquid-gas phase transitions are conventionally used to separate multicomponent liquid systems. The different evaporation temperatures enable the components to get collected separately. Such methods include distillation processes, pervaporation and vapour permeation. However, such methods are expensive, either because of the energy required for the separation of the components or the environmental regulations relating to emissions.

Another problem with methods which use high temperature treatments is that this may not be suitable for liquid phase systems that are temperature-sensitive, particularly in the case of chemical and/or biochemical compositions, where temperature must be strictly maintained stable within a narrow range.

There is, therefore, a need for an improved liquid phase separation method.

### SUMMARY OF THE INVENTION

The present invention seeks to address these problems, and/or to provide an improved liquid phase separation system.

In general terms, the invention relates to a nanocomposite coating for use in a liquid phase separation system, particularly to a nanocomposite coating on a matrix of porous solid material used in the separation system. The coating may act as a selective barrier so that mass transfer and diffusion into the matrix of porous solid material may be controlled by such selectivity.

According to a first aspect, the present invention provides a nanocomposite coating comprising:
a two-dimensional material; and
a polymer,
   wherein the nanocomposite coating is semi-permeable and is for providing on porous material to improve selectivity towards one phase over others thereby enabling separation of that phase by mass transfer.

The 2-dimensional material may be any suitable material. For example, the 2-dimensional material may be, but not limited to, a graphene-based material, a boron nitride-based material, or transition metal dichalcogenide, or a combination thereof. According to a particular aspect, the 2-dimensional material may be, but not limited to, graphene oxide (GO), hexagonal boron nitride (h-BN), molybdenum disulphide (MoS₂), or a combination thereof.

The polymer comprised in the coating may be any suitable polymer. For example, the polymer may be, but not limited to, polyvinyl alcohol (PVA), chitosan, polyvinylpyrrolidone (PVP), cellulose, agarose, or co-polymers thereof.

The coating may have a suitable viscosity. According to a particular aspect, the coating may have a viscosity in the range of 100-10000 cps.

The porous material may be any suitable material. According to a particular aspect, the porous material may be a ceramic material. For example, the ceramic material may be but not limited to: SiC, zeolite, clay, gypsum, hydroxyapatite, alumina, or a combination thereof.

There is also provided, according to a second aspect of the present invention, a phase transformation and mass transfer unit comprising porous material coated with the nanocomposite coating according to the first aspect. In particular, the phase transformation and mass transfer unit may be comprised in a separation unit of a liquid phase separation system.

According to a third aspect, the present invention provides a low temperature liquid phase separation method, the method comprising:
providing a dragging gas stream;
flowing a liquid mixture through a phase transformation and mass transfer unit as described above to enable phase transformation and mass transfer of vapour phase; and
channelling the dragging gas stream through the phase transformation and mass transfer unit, the dragging gas stream being channelled to the phase transformation and mass transfer unit,
   wherein the vapour phase separates from the liquid mixture and becomes incorporated in the dragging gas stream.

According to a particular aspect, the method may be carried out at a temperature of 20-40° C.

The dragging gas stream may comprise any suitable gas. For example, the dragging gas stream may comprise: nitrogen, hydrogen, inert gas, air, or a mixture thereof.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings. In the drawings:

FIG. 1 shows a schematic representation of a liquid phase separation system according to one embodiment of the present invention.

### DETAILED DESCRIPTION

As explained above, there is a need for an improved liquid phase separation method.

In particular, the present invention provides a method in which liquid phase separation may occur at a suitable temperature, particularly at temperatures which are as low as possible from the boiling temperatures of the components comprised in the liquid mixture to be separated. Even more in particular, the method of the present invention is a low temperature liquid phase separation method.

The present invention also provides a nanocomposite coating provided on porous material such that the nanocomposite coating enhances the mass transfer and diffusion of gas phase into the porous material. As a result, a high temperature is not required for the liquid phase separation.

According to a first aspect, the present invention provides a nanocomposite coating comprising:
a two-dimensional material; and
a polymer,
   wherein the nanocomposite coating is semi-permeable and is for providing on porous material to improve selectivity towards one phase over others thereby enabling separation of that phase by mass transfer.

For the purposes of the present invention, a nanocomposite coating is defined as a coating comprising two or more materials, each material having different chemical properties and wherein at least one dimension of a particle of one of the materials comprised in the nanocomposite is ≤1000 nm.

The coating may be in any suitable form. For example, the coating may be in the form of a slurry, paint, and the like.

The 2-dimensional material may be any suitable material. For example, the 2-dimensional material may be, but not limited to, a graphene-based material, a boron nitride-based material, or transition metal dichalcogenide, or a combination thereof. According to a particular aspect, the 2-dimensional material may be, but not limited to, graphene oxide (GO), hexagonal boron nitride (h-BN), molybdenum disulphide (MoS₂), or a combination thereof. In particular, the 2-dimensional material may be graphene oxide (GO).

The 2-dimensional material may be in any form. According to a particular aspect, the 2-dimensional material may be in the form of a suspension.

The coating may comprise a suitable concentration of the 2-dimensional material. For example, the concentration of the 2-dimensional material may be ≤95 weight % based on the total weight of the coating.

The polymer comprised in the coating may be any suitable polymer. According to a particular aspect, the polymer may be any suitable polymer which is able to be processed in water and solvents. The polymer may be a low toxicity polymer. The polymer may be able to form a strong interaction with the 2-dimensional material comprised in the coating. For example, the polymer may be, but not limited to, polyvinyl alcohol (PVA), chitosan, polyvinylpyrrolidone (PVP), cellulose, agarose, or co-polymers thereof. In particular, the polymer may be PVA.

The coating may comprise a suitable concentration of the polymer. For example, the concentration of the polymer may be 50-99 weight % based on the total weight of the coating. In particular, the concentration may be 95-99 weight % based on the total weight of the coating.

The coating may have a suitable viscosity. The viscosity of the coating may depend on the porous material onto which the coating is provided. In particular, the viscosity of the coating may induce a laminar flow on the porous material onto which the coating is to be provided such that maximum alignment of the coating on the porous material may be achieved. According to a particular aspect, the coating may have a viscosity in the range of 100-10000 cps.

The porous material may be any suitable material for the purposes of the present invention. According to a particular aspect, the porous material may be a ceramic material. For example, the ceramic material may be, but not limited to: SiC, zeolite, clay, gypsum, hydroxyapatite, alumina, porous industrial ceramics, porous powder metallurgy materials, or composites, nanocomposites, nano-structured composites thereof, or a combination thereof.

The coating may be prepared by any suitable method. For example, the coating may be prepared by mixing the 2-dimensional material with the polymer to obtain the coating. According to a particular aspect, a solution of the polymer may be prepared and a suspension of the 2-dimensional material may be prepared. The solution of the polymer and the suspension of the 2-dimensional material may be mixed and homogenised. Further 2-dimensional material may be added to the homogenised mixture and further homogenised to form the coating.

According to a particular embodiment, the method of preparing the coating comprises preparing a solution of 99% hydrolysed PVA with a concentration of 111.11 mg/ml. Separately, a suspension of GO with a concentration of 0.2 mg/ml is prepared. 3 ml of the PVA solution are added to 7 ml of the GO suspension and the mixture is homogenized for 10 minutes in a vortex mixer. To this mixture, 1 ml of 1 mg/ml concentrated GO suspension and 1 ml of 0.6 mg/ml of NaHSO₄ treated GO are added.

The mixture is again homogenized for 10 minutes in a vortex mixer. The resulting solution is diluted to a total volume up to 50 ml to achieve a suitable viscosity for applying the mixture as a coating on porous material. The viscosity value may depend on the specific porous material used.

The coating may be provided on the porous material by any suitable method. For example, the coating may be provided on the porous material by, but not limited to, spray coating, slip-rotation, doctor blading, and the like. According to a particular aspect, the coating may be provided on the porous material during the course of the liquid phase separation in which the porous material is used. For example, the coating may be applied and dried before a liquid mixture to be separated is provided to a system. The coating may be supplied as a slurry, and vapour phase removal during the course of the liquid phase separation will enable the coating to get deposited across an inner surface of a module of porous material used in the separation. Once a suitable thickness is achieved, the remaining slurry may be removed and the film may be dried.

The 2-dimensional-based nanocomposite coating according to the present invention may enhance the selectivity properties of the porous material onto which the coating is provided, so that the porous material may be used in liquid phase separation methods. Furthermore, other physical and chemical properties of the porous materials, such as hydrophilic to hydrophobic transition or vice-versa can be applied as a primer treatment for other applications.

According to a second aspect of the present invention, there is provided a phase transformation and mass transfer unit comprising porous material coated with the nanocomposite coating according to the first aspect.

The porous material may be any suitable porous material. For example, the porous material may be as described above.

The phase transformation and mass transfer unit may be any suitable unit. In particular, the phase transformation and mass transfer unit may be one which is suitable for use in liquid phase separation methods.

The phase transformation and mass transfer unit may comprise any suitable configuration. According to a particular aspect, the phase transformation and mass transfer unit may comprise one or more tubular modules of the porous material described above coated with the nanocomposite coating according to the first aspect. The coating provides a selectivity function of some phases over other phases, so that the mass transfer processes may be improved by the selectivity.

According to a particular aspect, the phase transformation and mass transfer unit may be comprised in a separation unit of a liquid phase separation system.

The separation unit may be any suitable separation unit. For example, the separation unit may be any suitable separation unit for use in a liquid phase separation system. In particular, the separation unit is one in which separation of liquid mixtures and mass transfers may be performed, wherein the separation process occurs in the phase transformation and mass transfer unit comprised in the separation unit.

According to a particular aspect, the separation unit may further comprise a gas inlet, a gas outlet, a liquid inlet and a liquid outlet. In particular, the separation unit may be configured to receive dragging gas through the gas inlet and a liquid mixture through the liquid inlet. The separation unit may also be configured to discharge vapour rich dragging gas through the gas outlet and treated liquid through the liquid outlet.

In particular, the phase transformation and mass transfer unit enable separation of liquid mixtures based on an evaporation method, in which the liquid mixture fed into the phase transformation and mass transfer unit may be at room or lower temperatures and the outlet components such as the vapour rich dragging gas and the treated liquid are obtained and collected in the form of separate gas and/or liquid phases. The evaporation method may be based on a combination of the acting capillary pressure driving the mass transfer and evaporation in the porous materials; and enhanced selectivity effect of a nanocomposite coating comprised in the phase transformation and mass transfer unit. The nanocomposite coating may be as described above. In particular, the nanocomposite coating may comprise a 2-dimensional material. Even more in particular, the nanocomposite coating may comprise a graphene-based material. Therefore, the phase transformation and mass transfer unit according to the present invention may be used in a variety of fields in which separation of liquid phase is required and in which the components comprised in the liquid phase are sensitive to high temperature. Accordingly, the phase transformation and mass transfer unit according to the present invention may be used in, but not limited to, the pharmaceutical and food/beverages industry, fuel industry, and the like.

In use, a liquid mixture enter the separation unit through the liquid inlet and may flow through the phase transformation and mass transfer unit comprised in the separation unit, particularly through the one or more tubular modules of the porous material coated with the nanocomposite coating as described above. The liquid mixture may flow through the tubular modules in specific flux conditions which allow necessary phase transformation process, as well as mass transfer of vapour phase inside the porous material of the tubular module walls. Simultaneously, the dragging gas may enter the separation unit through the gas inlet. For example, the dragging gas may flow in a direction parallel to an external wall of the phase transformation and mass transfer unit. The dragging gas accelerates the phase transformation and mass transfer of vapour and carries separated vapour phase out of the pores of the porous material to enable the vapour phase to be incorporated into the dragging gas and subsequently exits the separation unit through the gas outlet. The treated liquid mixture may flow continuously through the tubular modules towards the liquid outlet.

The one or more tubular modules of porous material may be arranged in any suitable arrangement. For example, the tubular modules may be arranged in fixed positions and supported by scaffolds. The scaffolds may be of any suitable material. For example, the scaffolds may be acrylic scaffolds. The scaffolds may further be fixed by channels which in turn are formed in the inner walls of the separation unit. The channels may be formed of any suitable material For example, the channels may be aluminium channels. The channels may be formed in the inner walls of the separation unit by any suitable means. For example, the channels may be welded to the inner walls of the separation unit. According to a particular aspect, the scaffolds may have a pattern of slits through which the tubular modules may pass.

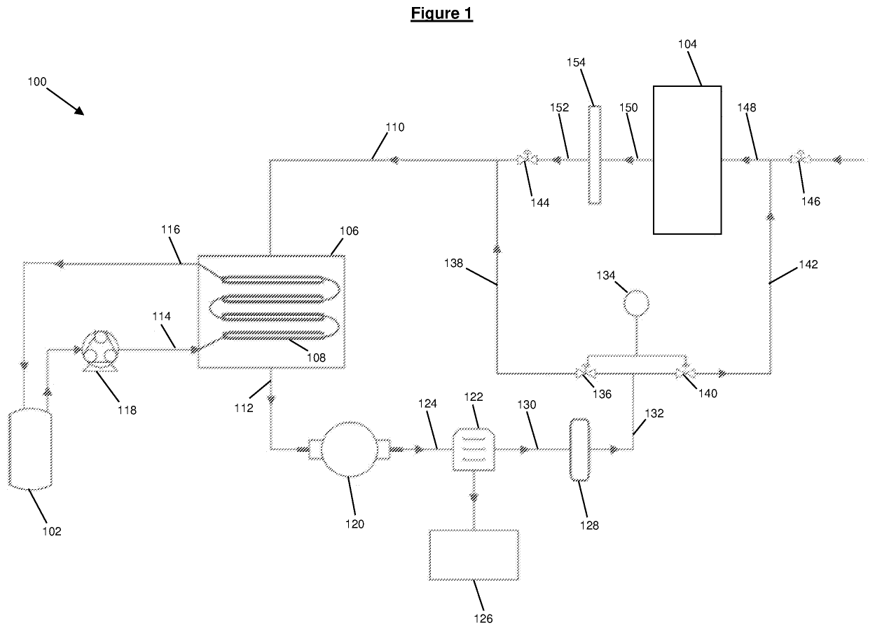

The separation unit as described above may in turn be comprised in a liquid phase separation system. An example of a liquid phase separation system is as shown in FIG. 1. FIG. 1 exemplifies a liquid phase separation system 100. System 100 comprises a supply tank 102 which is configured to contain the liquid mixture to be treated by the system 100. There is also provided a dragging gas generator 104 for generating dragging gas for use in the system 100, and a separation unit 106. The separation unit 106 may comprise at least one phase transformation and mass transfer unit 108. According to a particular aspect, the separation unit 106 and the phase transformation and mass transfer unit 108 may be as described above.

The system 100 may further comprise pipe connections to connect the various components of the system 100 to each other. In particular, separation unit 106 may comprise an inlet gas pipe 110 configured to supply dragging gas to the separation unit 106 and an outlet gas pipe 112 configured to remove vapour rich dragging gas out of the separation unit 106. The separation unit 106 may further comprise an inlet liquid pipe 114 configured to supply liquid mixture to the separation unit 106 and an outlet liquid pipe 116 configured to bring treated liquid out of the separation unit 106. A pump 118 may enable the liquid mixture to be pumped into the separation unit 106. The pump 118 may be any suitable pump for the purposes of the present invention. For example, the pump 118 may be a circulation pump, such as a peristaltic pump.

The system 100 may further comprise a pump 120 to pump the vapour rich dragging gas out of the separation unit 106 via outlet gas pipe 112 and into an air dryer 122 via a gas pipe 124. The pump 120 may be any suitable pump. For example, the pump 120 may be a vacuum pump. The air dryer 122 may be in fluid connection with a water collector 126 configured to collect condensed water from the air dryer 122.

The system 100 may further comprise an absorption column 128 which may be in fluid connection to the air dryer 122 via gas pipe 130. There is also provided a sensor 134 in fluid connection with absorption column 128 via gas pipe 132. The system 100 may also comprise valves 136, 140, 144 and 146 to control the flow of various components within the system 100, as well as gas pipes 138, 142, 148, 150 and 152 to enable the various components to be circulated within the system 100. There is also provided a temperature controller 154 configured to control the temperature of dragging gas generated from dragging gas generator 104.

According to a third aspect, the present invention provides a low temperature liquid phase separation method, the method comprising:
providing a dragging gas stream;
flowing a liquid mixture through a phase transformation and mass transfer unit as described above to enable phase transformation and mass transfer of vapour phase; and
channelling the dragging gas stream through the phase transformation and mass transfer unit, the dragging gas stream being channelled to the phase transformation and mass transfer unit,
   wherein the vapour phase separates from the liquid mixture and becomes incorporated in the dragging gas stream.

Mass transfer of the vapour phase from the liquid mixture to the dragging gas stream may be by capillary-driven mass transport through the porous material comprised in the phase transformation and mass transfer unit. In particular, the nanocomposite coating may enhance the molecular separation of the vapour phase by causing the vapour phase to percolate through the porous material and flow through a capillary pressure gradient towards the separation unit to be dispersed and carried out of the separation unit by the dragging gas stream.

According to a particular aspect, the flowing a liquid mixture through a phase transformation and mass transfer unit may comprise coating the porous material comprised in the phase transformation and mass transfer unit with the nanocomposite coating. In particular, capillary-driven mass transport through the porous material may allow the nanocomposite coating to be deposited on the porous material.

According to a particular aspect, the method may be carried out at a temperature of 20-40° C. In particular, the method may be carried out at room temperature therefore negating the need of heating, as well as enabling the method of the present invention to be applied across many industries, such as the pharmacological, food and beverage industries, in which liquid phase separation is required at room temperatures since the liquid phase comprises temperature sensitive components.

Further, due to the absence of any heating, the method requires less energy than conventional evaporation methods in which the evaporation is based on the liquid gas transformation at boiling temperatures of the liquid involved. The method also enables easy recovery of residual liquids and gases such as water and carbon dioxide, in view of the low temperatures involved in the method.

In general terms, the method of the present invention involves a liquid mixture of interest to be propelled by a pump from a supply tank to a phase transformation and mass transfer unit under specific flux conditions that allow the necessary phase transformation process, as well as mass transfer of vapour phases from the liquid mixture to a dragging gas, the mass transfer enabled by porous material comprised in the phase transformation and mass transfer unit as described above.

According to a particular aspect, the flowing may be under suitable conditions. For example, the conditions may be such so as to achieve maximum permeation of a vapour phase through the porous material coated with the nanocomposite coating and resulting in minimum fouling.

Furthermore, the dragging gas stream is established such that it flows outside the walls of the phase transformation and mass transfer unit, for example in a parallel direction to the phase transformation and mass transfer unit. The dragging gas stream accelerates phase transformation processes inside the porous material comprised in the phase transformation and mass transfer unit and drags the separated vapour phases out of the pores of the porous material and incorporates the separated vapour phase in the dragging gas stream. The dragging gas stream may comprise any suitable gas. The type of dragging gas depends on the specific liquid mixture and separation task to be fulfilled, so that different gases and their mixtures may be employed. For example, the dragging gas stream may comprise: nitrogen, hydrogen, an inert gas, air, or a mixture thereof. The inert gas may be nitrogen, argon, helium, neon, or a mixture thereof.

The method of the present invention will now be described in relation to the system 100 as described above.

A liquid mixture to be separated may be contained in the supply tank 102 and may be propelled by the pump 118 through the inlet liquid pipe 114 to an inlet of the separation unit 106 for processing in continuous flux. After processing, the flux of the treated liquid phase or liquid mixture returns to the supply tank 102 through the outlet liquid pipe 116. The method may comprise extracting a test sample from the supply tank 102 for analysis. The method may be performed continuously until the treated liquid phase or liquid mixture in the supply tank 102 reaches a pre-determined final composition.

The phase separation method may be carried out inside the phase transformation and mass transfer unit 108 within the separation unit 106. The phase transformation and mass transfer unit 108 may be as described above. The liquid mixture from the supply tank 102 which enters the separation unit 106 may flow through tubular modules of the phase transformation and mass transfer unit 108 under specific flux conditions that allow the necessary phase transformation process, as well as mass transfer of vapour phases from inside the porous material comprised in the phase transformation and mass transfer unit 108. In particular, the dragging gas stream outside the walls of the phase transformation and mass transfer unit 108 accelerates the phase transformation and mass transfer and carries the separated vapour phases out of the pores of the porous material, so that the vapour phases are incorporated into the dragging gas stream and dragged out of the separation unit 106 to the outlet gas pipe 112. The treated liquid phase or liquid mixture flows continuously through the tubular modules of the phase transformation and mass transfer unit 108 and out of the separation unit 106 via the outlet liquid pipe 116, which carries the treated liquid back to the supply tank 102.

In particular, the working mechanism of the system 100 involves the type of dragging gas, the dragging gas pressure, the pressure of the vacuum pump 120, the dragging gas velocity inside the separation unit 106, the effective working area of porous material in the phase transformation and mass transfer unit 108 and the velocity of the liquid mixture at the inlet liquid pipe 114 and the outlet liquid pipe 116, which are regulated by the pump 118. The working temperature of the system 100 and the liquid mixture may be regulated in a temperature range from below room temperature up to room temperature. For temperatures lower than room temperature, an optional cooler unit may be installed within the system 100.

The outlet gas pipe 112 carrying the vapour rich dragging gas may be thrusted through the gas pipe 124 due to the pump 120 into the air dryer 122. The air dryer may further comprise a water condensation unit to enable recovery and collection of pure water from the vapour rich dragging gas into water collector 126. An absorption column 128, for example with MEA 7, may be provided to enable extraction of CO₂ from the dragging gas in the gas pipe 128 following passing through the air dryer 122. The absorption column 128 may be an optional component in the system 100. After drying, and optional CO₂ extraction, the dragging gas may be carried through gas pipe 132 to the sensor 134, whose function is to determine the dragging gas content, and thereby to control the valves 136 and 140. The valve 136 will be open and the valve 140 will be closed if the dragging gas content is appropriately high for re-use in the system 100, so that the dragging gas may be directed to gas pipe 138. Otherwise, the valve 136 will be closed and the valve 140 will be open if the dragging gas content of the flowing gas is not appropriately high for re-use in the system 100, so that the dragging gas is directed to the dragging gas generator 104 for recycling. The function of the valve 146 is to regulate the necessary air flux to be mixed with the recycled dragging gas in the gas pipe 142. The mixture of air and recycled dragging gas may be carried through gas pipe 148 into the dragging gas generator 104 for dragging gas production.

The dragging gas generator 104 is the source that produces and thrusts dragging gas into the system 100 which is a closed system. The valve 144 regulates the supply of the dragging gas produced from the dragging gas generator 104, which is thrusted into the system 100 after passing through the gas pipe 150, the temperature controller 154 and the gas pipe 152. The function of the temperature controller 154 is to regulate the dragging gas temperature. The valve 144 may be closed when the re-using gas flux in the gas pipe 138 is appropriate for supplying to the system 100, so that no new dragging gas from the dragging gas generator 104 is necessary. The inlet gas pipe 110 may supply and sustain the dragging gas stream in the separation unit 106.

The dragging gas stream direction inside the separation unit 106 may be parallel to the external walls of the phase transformation and mass transfer units 108. The circulation and direction of the dragging gas stream, together with the extracted vapour phase, may sustain the synchronized action of the dragging gas generator 104 and the pump 120, as well as the localization of the connections of the inlet gas pipe 110, and the outlet gas pipe 112. The gas pressure from the dragging gas generator 104 may vary. For example, the gas pressure may be from 1-5 bar. The user of the system 100 may select any suitable pressure suitable for the purposes of the present invention.

Whilst the foregoing description has described exemplary embodiments, it will be understood by those skilled in the technology concerned that many variations may be made without departing from the present invention. Further, the exemplary embodiments are only examples, and are not intended to limit the scope, applicability, operation or configuration of the invention in any way.

1. A nanocomposite coating comprising:
a 2-dimensional material; and
a polymer,
wherein the nanocomposite coating is semi-permeable and is for providing on porous material to improve selectivity towards one phase over others thereby enabling separation of that phase by mass transfer.

2. The coating according to claim 1, wherein the 2-dimensional material is a graphene-based material, boron nitride-based material or transition metal dichalcogenide, or a combination thereof.

3. The coating according to claim 1, wherein the 2-dimensional material is: graphene oxide (GO), hexagonal boron nitride (h-BN), molybdenum disulphide (MoS₂), or a combination thereof.

4. The coating according to claim 1, wherein the polymer is: polyvinyl alcohol (PVA), chitosan, polyvinylpyrrolidone (PVP), cellulose, agarose, or co-polymers thereof.

5. The coating according to claim 1, wherein the coating has a viscosity in the range of 100-10000 cps.

6. The coating according to claim 1, wherein the porous material is a ceramic material.

7. The coating according to claim 6, wherein the ceramic material is: SiC, zeolite, clay, gypsum, hydroxyapatite, alumina, or a combination thereof.

8. A phase transformation and mass transfer unit comprising porous material coated with the nanocomposite coating according to claim 1.

9. The phase transformation and mass transfer unit according to claim 8, wherein the phase transformation and mass transfer unit is comprised in a separation unit of a liquid phase separation system.

10. A low temperature liquid phase separation method, the method comprising:
providing a dragging gas stream;
flowing a liquid mixture through a phase transformation and mass transfer unit according to claim 8 to enable phase transformation and mass transfer of vapour phase; and
channelling the dragging gas stream through the phase transformation and mass transfer unit, the dragging gas stream being channelled to the phase transformation and mass transfer unit,
wherein the vapour phase separates from the liquid mixture and becomes incorporated in the dragging gas stream.

11. The method according to claim 10, wherein the method is carried out at a temperature of 20-40° C.

12. The method according to claim 10, wherein the dragging gas stream comprises: nitrogen, hydrogen, inert gas, air, or a mixture thereof.
